(19) United States
(12) Patent Application Publication
(10) Pub. No.: US 2012/0042173 A1
(43) Pub. Date: Feb. 16, 2012

(54) Digital Content and Right Object Management Systems and Methods

(75) Inventors: Chi-Yang Chou, Kao-hsiung (TW); Pei-Yen Chou, Hsin-chu (TW); Yeu-Chung Lin, Chang-hua (TW)

(73) Assignee: CONDEL INTERNATIONAL TECHNOLOGIES INC., George Town (KY)

(21) Appl. No.: 12/855,588

(22) Filed: Aug. 12, 2010

(51) Int. Cl. G06F 21/00; H04L 9/00

(52) U.S. Cl. 713/189; 726/27

(57) ABSTRACT

Digital content and rights object management systems and methods are provided. The system at least includes a storage device having a hardware UID, a public area and a hidden area. The public area at least includes a security management application. The hidden area at least includes a rights object and a specific ID. The specific ID is read and determined whether or not it matches with the hardware UID. When the specific ID matches with the hardware UID, the rights object is retrieved from the hidden area, and the rights object is delivered to a security management application of a playback device for playback. In some embodiments, the rights object may be encrypted, and the security management application can read the hardware UID of the storage device, and decrypt the rights object according to the hardware UID. In the present invention, the hardware UID of the storage device and the rights object stored in the hidden area which cannot be accessed by general consumers are used to manage the DRM content.

### BACKGROUND OF THE INVENTION

1. Field of the Invention

The disclosure relates generally to digital content and rights object management systems and methods, and, more particularly to systems and methods that manage DRM (Digital Rights Management) contents on a storage device according to hardware UID (unique identification) of the storage device and a rights object stored in the hidden area of the storage device.

2. Description of the Related Art

With electronic devices, such as computers or portable devices, being popular, digital content has become a major data recording type for the devices due to increased convenience of digital content. Moreover, content providers have been devoted to develop more related applications for digital content.

Currently, two conventional delivery manners can be used for digital content. In an off-line manner, digital content is stored in a disc, such as a CD/VCD/DVD. Users can play back the digital content at any time, and in any playback device. The rights management of content in discs is acceptable by most users. However, the mobility of discs is limited due to the size of discs. Additionally, in this manner, since digital rights management requires involvement of the content provider, playback device manufacturer, and disc manufacturer, the digital rights management method is inefficient as each party have different interests and benefits. Further, since content has been recorded in the discs, the playing back content type may limit efficiencies, and difficulties exist for development of cross-applications and business models for different contents.

In an on-line manner, DRM content and/or a rights object can be downloaded from an internet to a memory of a playback device. Once the DRM content and the rights object are delivered to the playback device, the DRM agent on the playback device stores the rights object to a place which is inaccessible to an ordinary user and bundles the rights object with a device code of the playback device. When an electronic appliance wants to access the content, it is determined whether or not the device code of the electronic appliance matches the device code bundled with the content file. If the device code of the electronic appliance matches the device code bundled with the content file, the electronic appliance is permitted to access and decrypt the content. In this manner, the content is forced to be bundled to a specific device, thus seriously limiting a user's fair use right of owning the content, since a user will not be able to access the content with other devices.

### BRIEF SUMMARY OF THE INVENTION

Digital content and rights object management systems and methods are provided.

An embodiment of a digital content and rights object management system includes a storage device at least having a hardware UID, a public area and a hidden area. The public area at least includes a security management application, an authentication module, a cryptography algorithm and maybe a DRM content. It is noted that the authentication module can be an integral part of the security management application or it can be a separated program. The hidden area at least includes a rights object, keys and a specific ID. The authentication module reads the specific ID from the hidden area and determines whether or not the specific ID matches with the hardware UID of the storage device. When the specific ID matches with the hardware UID of the storage device, the security management application retrieves the rights object from the hidden area of the storage device, and delivers the rights object to the security management application of a playback device which is engaging with the corresponding DRM content for playback. It is noted that, in some embodiments, the rights object may be encrypted by the security management application of the storage device or by a separated cryptography algorithm using a key which is a computational derivative of the UID. When the rights object is retrieved from the hidden area, the security management application of storage device or the separated cryptography algorithm will decrypt it using the related key.

In an embodiment of a digital content and rights object management method, a storage device at least including a hardware UID, a public area and a hidden area is provided. The public area at least includes a security management application, an authentication module, a cryptography algorithm and maybe a DRM content. The hidden area at least includes a rights object, keys and a specific ID. The specific ID is read from the hidden area and it is determined whether or not the specific ID matches with the hardware UID of the storage device by the authentication module. When the specific ID matches with the hardware UID of the storage device, the rights object is retrieved from the hidden area of the storage device by the security management application, and the rights object is delivered to the security management application of a playback device for playback. In some embodiments, the rights object may be encrypted.

In an embodiment of a digital content and rights object management method, DRM is performed to a content to obtain a DRM content and a rights object. The rights object and a hardware UID of the storage device are stored to a hidden area of a storage device. The DRM content is stored to a public area of the storage device or to a specific file directory of a playback device, and a security management application, an authentication module and a cryptography algorithm are stored to the public area of the storage device. It is noted that, in some embodiments, the rights object can be further encrypted according to the hardware UID of the storage device, and the encrypted rights object is stored to the hidden area of the storage device. When the DRM content is requested to be accessed, the authentication module reads the specific ID from the hidden area and determines whether or not the specific ID matches with the hardware UID of the storage device. When the specific ID matches with the hardware UID of the storage device, the security management application of the storage device retrieves the rights object from the hidden area of the storage device, and delivers the rights object to the security application module of the playback device for playback. As described, if the rights object maybe originally encrypted and is decrypted by the security management application of the storage device or the separated cryptography algorithm before it is handed over to the security management module of the playback device.

Digital content and rights object management methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a digital content and rights object management system according to the invention;

FIG. 2 is a schematic diagram illustrating an embodiment of a storage device according to the invention;

FIG. 3 is a flowchart of an embodiment of a digital content and rights object management method according to the invention; and

FIG. 4 is a flowchart of an embodiment of a digital content and rights object management method according to the invention.

### DETAILED DESCRIPTION OF THE INVENTION

Digital content and rights object management systems and methods are provided.

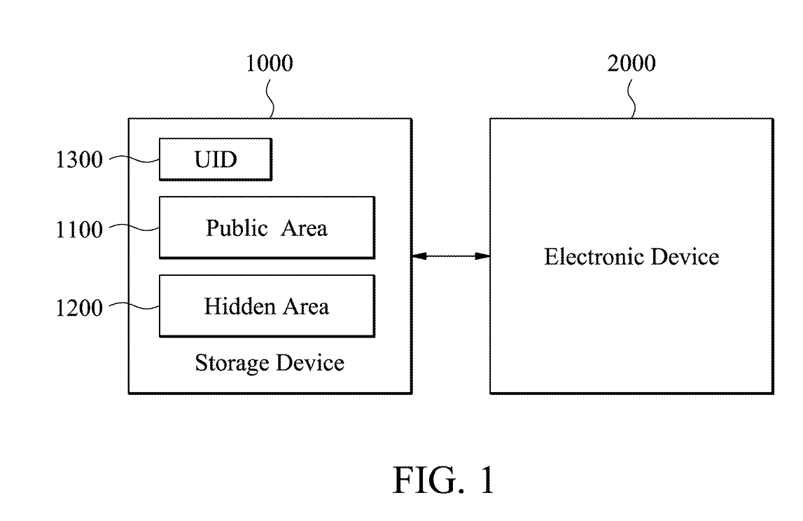

FIG. 1 is a schematic diagram illustrating an embodiment of a digital content and rights object management system according to the invention.

The digital content and rights object management system comprises a storage device 1000 and an electronic device 2000. The storage device 1000 may be a flash memory device, such as an SD (Secure Digital) card or a USB disk. The storage device 1000 at least comprises a public area 1100 and a hidden area 1200. It is noted that, the public area 1100 is accessible for general consumers. General consumers can read/write data in the public area 1100 at will. The hidden area 1200 cannot be accessed by general consumers, and data in the hidden area 1200 cannot be read and displayed via a card reader by a general customer. The storage device 1000 has a hardware UID 1300. It is understood that, in some embodiments, the storage device 1000 may comprise a semiconductor component, such as a memory or a micro-processor. The hardware UID 1300 is a hardware serial number generated for the semiconductor component during manufacturing or a virtual serial number created for the semiconductor component by firmware/software. The electronic device 2000 may be processor-based electronic devices, such as computers, or portable devices such as MP3 players, MP4 players, PDAs, global positioning devices or mobile phones. When the storage device is coupled to the electronic device 2000, the electronic device 2000 can executes related applications and modules in the storage device 1000.

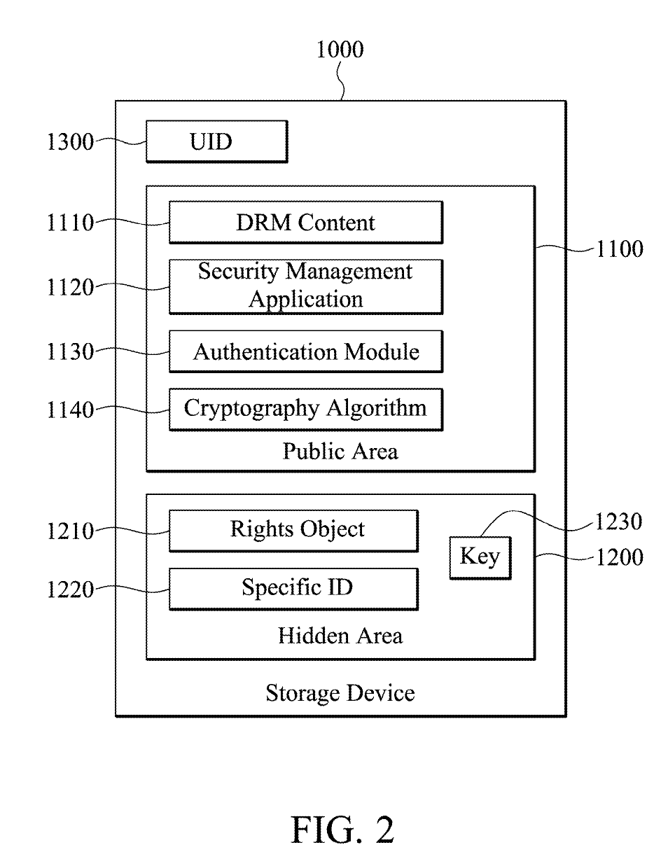

FIG. 2 is a schematic diagram illustrating an embodiment of a storage device according to the invention.

The storage device 1000 may be a flash memory device, such as an SD (Secure Digital) card or a USB disk. The storage device 1000 at least comprises a public area 1100 and a hidden area 1200. The public area 1100 may comprises a DRM content 1110, a security management application 1120, an authentication module 1130 and a cryptography algorithm 1140. It is understood that, the DRM content 1100 maybe stored either on the storage device 1000 or a specific directory on a playback device. It is understood that, the authentication module 1130 and the cryptography algorithm 1140 may be an integral part of the security management application 1120 or separated programs. The DRM content 1110 is a content, wherein DRM is performed. The hidden area 1200 at least comprises a rights object 1210 corresponding to the DRM content 1110, keys 1230 and a specific ID 1220. It is understood that, DRM may be performed to a content to obtain the DRM content 1110, such as a .dcf file in the OMA (Open Mobile Alliance) DRM, and the rights object 1210. When the authentication module 1130 is executed, a hardware UID 1300 of the storage device 1000 is read and compared with the specific ID 1220. When the hardware UID 1300 matches with the specific ID 1220, the DRM content 1110 is allowable to be accessed, for example, to be read by a security management application of a playback device of the electronic device 2000. It is understood that, in some embodiments, the storage device 1000 may comprise a semiconductor component, such as a memory or a micro-processor. The hardware UID 1300 is a hardware serial number generated for the semiconductor component during manufacturing or a virtual serial number created for the semiconductor component by firmware/software. The security management application 1120 can be read and executed by an electronic device (not shown). When the security management application 1120 is executed, the security management application 1120 can retrieve the rights object 1210 from the hidden area, and delivered the rights object 1210 to a security management application of a playback device (not shown) for playback. The playback device has a security management application performing DRM to receive the rights objects 1210 and access the associated DRM content 1110, and accordingly play back the DRM content 1110.

In some embodiments, the rights object 1210 may be encrypted. The rights object 1210 may be encrypted according to a key which is a computational derivative of the hardware UID 1300 of the storage device 1000 by the security management application 1120 or the cryptography algorithm 1140, and the encrypted rights object 1210 is stored to the hidden area 1200 of the storage device 1000. When the security management module 1120 retrieves the encrypted rights object 1210, the security management application 1120 or the cryptography algorithm 1140 will decrypt the rights object and deliver the rights object to the security management application of the playback device.

Additionally, it is understood that, in some embodiments, the electronic device 2000 may have a rights object pool (not shown) storing rights objects corresponding to respective DRM contents. In some embodiments, the security management application of the playback device of the electronic device 2000 can first try to access the DRM content 1110 and check whether or not the rights object corresponding to the DRM content 1110 is already in the rights object pool. If the rights object corresponding to the DRM content 1110 is already in the rights object pool, the electronic device 2000 executes the playback device to play back the DRM content 1110 based on the corresponding rights object in the rights object pool. If the rights object corresponding to the DRM content 1110 is not in the rights object pool, the security management application of the playback device can transmit a signal to the security management application 1120 of the storage device 1000, and the security management application 1120 retrieves the rights object 1210 corresponding to the DRM content 1110 from the hidden area 1200 of the storage device 1000, and delivers the rights object 1210 corresponding to the DRM content 1110 to the security management application of the playback device.

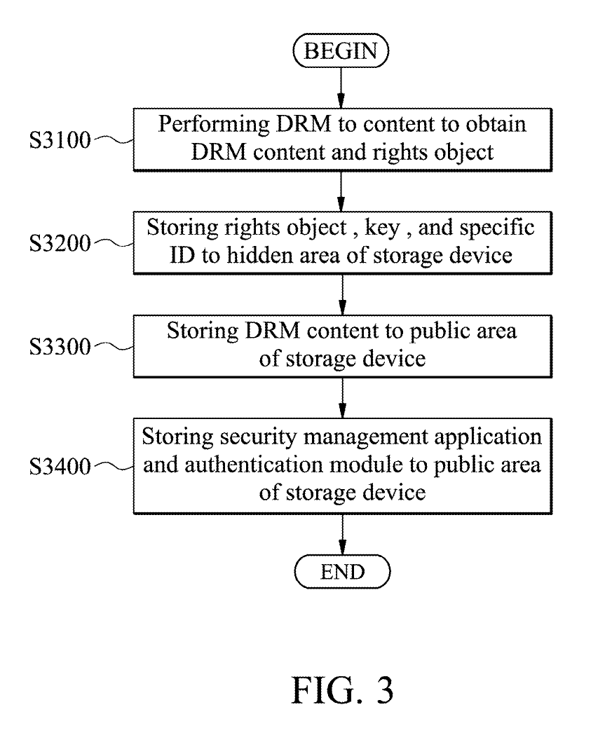

FIG. 3 is a flowchart of an embodiment of a digital content and rights object management method according to the invention. In this embodiment, a storage device having DRM content is produced.

In step S3100, DRM is performed to a content to obtain DRM content 1110 and a rights object 1210. It is understood that, the DRM can vary according to different requirements and applications. In step S3200, the rights object 1210, keys 1230, and a hardware UID of the storage device 1000 as the specific ID 1220 are stored to the hidden area 1200 of the storage device 1000. Similarly, in some embodiments, the storage device 1000 may comprise a semiconductor component, such as a memory or a micro-processor. The hardware UID 1300 is a hardware serial number generated for the semiconductor component during manufacturing or a virtual serial number created for the semiconductor component by firmware/software. Similarly, in some embodiments, the rights object 1210 can be further encrypted according to a key which is a computational derivative of the hardware UID 1300 of the storage device 1000, and the encrypted rights object 1210 can be stored to the hidden area 1200 of the storage device 1000. In step S3300, the DRM content 1110 may be stored to the public area 1100 of the storage device 1000 or a specific file of a playback device. In step S3400, a security management application 1120, an authentication module 1130, and a cryptography algorithm 1140 are stored to the public area 1100 of the storage device 1000. Similarly, the authentication module 1130 and the cryptography algorithm 1140 may be an integral part of the security management application 1120 or separated programs.

When the authentication module 1130 is executed, a hardware UID 1300 of a storage device 1000 storing the DRM content 1110 is read and compared with the specific ID 1220 already stored in the hidden area 1200 of the storage device 1000. When the hardware UID 1300 matches with the specific ID 1220 already stored in the hidden area 1200 of the storage device 1000, the rights object 1210 is allowable to be retrieved from the hidden area 1200 by the security management application 1120. When the security management application 1120 is executed, the rights object 1210 is retrieved from the hidden area 1200 and delivered to the security management application of the playback device for the playback of the DRM content.

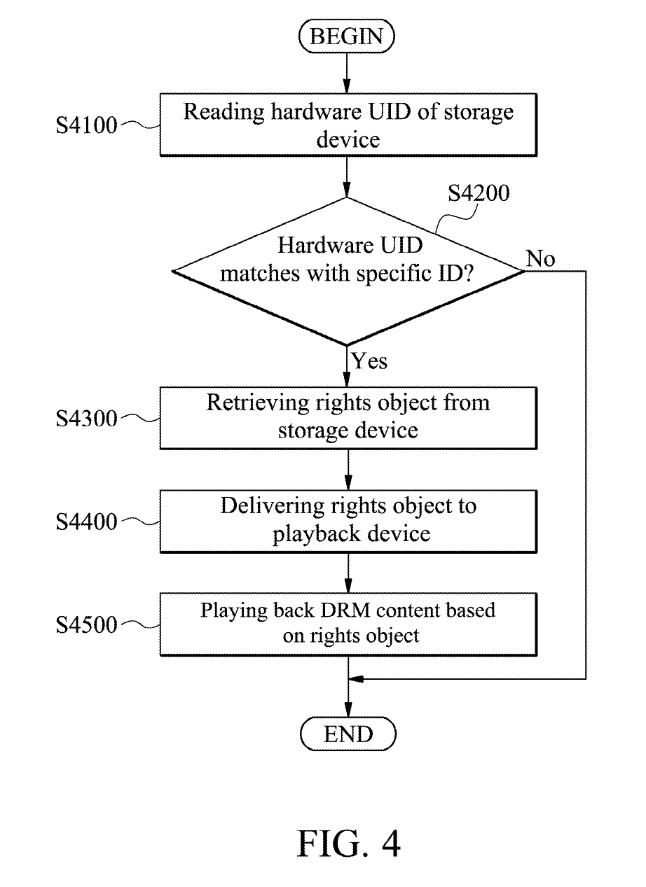

FIG. 4 is a flowchart of an embodiment of a digital content and rights object management method according to the invention.

When the DRM content 1110 in the storage device 1000 is requested to be played back, in step S4100, the authentication module 1130 is activated to read the hardware UID 1300 of the storage device 1000, and in step S4200, it is determined whether or not the hardware UID 1300 matches with the specific ID 1220 in the hidden area 1200 of the storage device 1000. Similarly, the storage device 1000 may comprise a semiconductor component, such as a memory or a micro-processor of the storage device. The hardware UID 1300 may be a hardware serial number generated for the semiconductor component during manufacturing or a virtual serial number created for the semiconductor component by firmware/software. If the hardware UID 1300 does not match with the specific ID 1220 (No in step S4200), the procedure is terminated. If the hardware UID 1300 matches with the specific ID 1220 (Yes in step S4200), in step S4300, the security management application 1120 is activated to retrieve the rights object 1210 from the hidden area 1200 of the storage device 1000. In step S4400, the security management application 1120 delivers rights object 1210 to the security management application of a playback device. In step S4500, the playback device performs the security management application to the DRM content 1110 based on the rights object 1210, and plays back the DRM content 1110. Similarly, if the rights object 1210 is encrypted, the security management application 1120 or the cryptography algorithm 1140 can read a key which is a computational derivative of the hardware UID 1300 of the storage device 1000, and decrypt the encrypted rights object 1210 according to the key.

It is noted that, as described, in some embodiments, the electronic device 2000 may have a rights object pool (not shown) storing rights objects corresponding to respective DRM contents. In some embodiments, the security management application of the playback device can first try to access the DRM content 1110. The security application module of the playback device can check whether or not the rights object corresponding to the DRM content 1110 is already in the rights object pool. If the rights object corresponding to the DRM content 1110 is already in the rights object pool, the security application module of the playback device plays back the DRM content 1110 based on the corresponding rights object in the right objects pool. If the rights object corresponding to the DRM content 1110 is not in the rights object pool, the security application module of the playback device can transmit a signal to the security management application 1120, and the security management application 1120 retrieves the rights object 1210 corresponding to the DRM content 1110 from the hidden area 1200 of the storage device 1000, and delivers the rights object 1210 corresponding to the DRM content 1110 to the electronic device 2000.

Therefore, the methods and systems of the application can store DRM contents in storage devices, and perform DRM according to hardware UID (unique identification) of the storage device and a rights object stored in the hidden area of the storage device. In some embodiments of the present disclosure, two security mechanisms can be provided for DRM, in which, for the storage device, the hardware UID of the storage device is first authenticated to determine whether or not it conforms to the specific ID recorded in the hidden area, and further, for the playback device, the hardware UID of the storage device is also verified to determine whether or not it can successfully decrypt the encrypted rights object, thus reducing the drawbacks for conventional content management systems and methods.

Digital content and rights object management methods, or certain aspects or portions thereof, may take the form of a program code (i.e., executable instructions) embodied in tangible media, such as flash card or USB disk, wherein, when the program code is loaded into and executed by a machine, such as a computer, the machine thereby becomes an apparatus for practicing the methods.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A digital content and rights object management system, comprising:
a storage device, comprising:
a hardware UID;
a public area comprising a security management application, an authentication module, a cryptography algorithm and maybe a DRM content; and
a hidden area comprising a rights object, keys and a specific ID,
wherein the authentication module reads the specific ID from the hidden area and determines whether or not the specific ID matches with the hardware UID of the storage device, and when the specific ID matches with the hardware UID of the storage device, the security management application retrieves the rights object from the hidden area of the storage device, and delivers the rights object to a security management application of a playback device for playback.

2. The system of claim 1, wherein the authentication module and the security management application are executed by an electronic device when the storage device is coupled by the electronic device.

3. The system of claim 1, wherein the storage device comprises a semiconductor component, and the hardware UID is a hardware serial number generated for the semiconductor component during manufacturing or a virtual serial number created for the semiconductor component by firmware/software.

4. The system of claim 3, wherein the semiconductor component comprises a memory or a micro-processor of the storage device.

5. A digital content and rights object management method, comprising:
providing a storage device comprising a hardware UID, a public area and a hidden area, wherein the public area comprises a security management application, an authentication module, a cryptography algorithm and maybe a DRM content, and the hidden area comprises a rights object, keys and a specific ID;
reading the specific ID from the hidden area and determining whether or not the specific ID matches with the hardware UID of the storage device by the authentication module; and
when the specific ID matches with the hardware UID of the storage device, retrieving the rights object from the hidden area of the storage device by the security management application, and delivering the rights object to a security management application of a playback device for playback.

6. The method of claim 5, wherein the authentication module and the security management application is read and executed by an electronic device when the storage device is coupled by the electronic device.

7. The method of claim 5, wherein the storage device comprises a semiconductor component, and the hardware UID is a hardware serial number generated for the semiconductor component during manufacturing or a virtual serial number created for the semiconductor component by firmware/software.

8. The method of claim 7, wherein the semiconductor component comprises a memory or a micro-processor of the storage device.

9. The method of claim 5, further comprising reading the hardware UID of the storage device, and decrypting the rights object according to the hardware UID by the security management application or the cryptography algorithm.

10. A digital content and rights object management method, comprising:
performing DRM (Digital Rights Management) to a content to obtain a DRM content and a rights object;
storing the rights object to a hidden area of a storage device;
storing a hardware UID of the storage device to the hidden area of the storage device;
storing the DRM content to a public area of the storage device or a specific directory of a playback device; and
storing a security management application, an authentication module and a cryptography algorithm to the public area of the storage device,
wherein when the DRM content is requested to be accessed, the authentication module reads the specific ID from the hidden area and determines whether or not the specific ID matches with the hardware UID of the storage device, and when the specific ID matches with the hardware UID of the storage device, the security management application retrieves the rights object from the hidden area of the storage device, and delivers the rights object to a security management application of a playback device for playback.

11. The method of claim 10, wherein the storage device comprises a semiconductor component, and the hardware UID is a hardware serial number generated for the semiconductor component during manufacturing or a virtual serial number created for the semiconductor component by firmware/software.

12. The method of claim 11, wherein the semiconductor component comprises a memory or a micro-processor of the storage device.

13. The method of claim 10, further comprising encrypting the rights object according to the hardware UID, and storing the encrypted rights object to the hidden area of the storage device.
